(19) United States
(12) Patent Application Publication
(10) Pub. No.: US 2016/0183741 A1
(43) Pub. Date: Jun. 30, 2016

(54) Adjustable Foot and Toe Cleaning Device

(71) Applicant: Vincent Atchison, Allen Park, MI (US)

(72) Inventor: Vincent Atchison, Allen Park, MI (US)

(21) Appl. No.: 14/837,284

(22) Filed: Aug. 27, 2015

Related U.S. Application Data
(60) Provisional application No. 62/043,084, filed on Aug. 28, 2014.

(51) Int. Cl. A47K 7/02; B25G 1/06; B25G 1/04; B08B 7/02

(52) U.S. Cl. CPC A47K 7/026; B08B 7/02; B25G 1/06; B25G 1/04

(57) ABSTRACT

An adjustable foot and toe cleaning device comprises an elongate handle and a head implement coupled to said elongate handle. The head implement includes at least one of a brush element, a porous element, and at least one finger-like projection. The porous element may comprise pumice stone or a sponge, for example. Where there is more than one finger-like projection, such projections may be attached to the head implement at a common point. The finger-like projections may selectively vibrate by way of a vibration mechanism. The elongate handle may be adjustable in length and as to its angular configuration. The device provides for easy access and cleaning of body parts, including extremities, with a minimum of effort and without requiring the user to unduly contort him or herself.

### CROSS-REFERENCE TO RELATED APPLICATIONS

The present application claims priority under 35 U.S.C. §119 on the U.S. provisional patent application, Ser. No. 62/043,084, filed on Aug. 28, 2014, the disclosure of which is incorporated by reference.

### FIELD OF DISCLOSURE

The present disclosure relates to a foot and toe cleaning device, and more particularly to an adjustable foot and toe cleaning device with detachable replacement components, for allowing a user to easily and safely clean his or her feet and toes, with minimal bending and minimal bodily harm, due to movement in the shower or while bathing.

### BACKGROUND OF DISCLOSURE

Many people elect to use special devices for cleaning their feet and toes in lieu of a standard brush, sponge, or other items. Typically, foot and toe cleaning devices comprise some form of handle for holding the device and a cleaning element, such as a brush or pumice stone, for cleaning the user's feet and toes or for exfoliating the skin thereon. While these devices may assist somewhat in the cleaning process, they lack the sophistication necessary to maximize cleaning efficiency and/or make the cleaning process easy for the user. Firstly, such devices generally comprise only a single cleaning element; however, different portions of the human foot require different cleaning components. For example, while a large cleaning brush may be optimal for cleaning the top and bottom of a user's foot, a smaller brush would be preferable for cleaning in between his or her toes.

Another common issue with foot and toe cleaning devices is that they require the user to bend or otherwise move or contort their body in a way that may be physically difficult or impossible for the user. By way of example, these devices are often short in length and therefore require the user to bend his or her body in order for the device to reach his or her feet and toes. This can be overly strenuous on persons incapable of so bending, and such persons may accidentally injure themselves in the process of using such devices. In other situations, the particular shape of the device prevents the user from accessing all areas of his or her feet and toes, which may result in unsuccessful cleaning and/or injury to the user should he or she attempt to access physically unreachable portions by contorting his or her body.

A further problem with these devices is that the components that actually perform the cleaning (e.g. the brush or pumice stone) tend to wear out over time, and, generally, they cannot be removed from such device without causing significant damage thereto. Upon such an occurrence, the user is forced to choose between refraining from further using the device, continuing to use the device despite its diminished cleaning efficiency and potential, and purchasing a new cleaning device.

As such, and notwithstanding the other benefits prescribed by foot and toe cleaning devices known in the art, it is apparent that the prior art fails to disclose an adjustable foot and toe cleaning device for allowing a user to easily clean his or her feet and toes with minimal effort and minimal bodily movement.

Accordingly, it is an object of the present disclosure to provide a foot and toe cleaning device that overcomes the shortcomings known in the art. It is further an object of the present disclosure to provide a foot and toe cleaning device specially designed to clean each portion of a user's feet and toes, or to allow a caregiver, spouse, podiatrist, nail technician, for example, to clean each portion of a person, patient, or client's feet and toes. It is further an object of the present disclosure to provide a foot and toe cleaning device that is shaped or may be adjusted to access each portion of a user's feet and toes with minimal effort and bodily movement. It is further an object of the present disclosure to provide a foot and toe cleaning device wherein the cleaning components are removably coupled so that a user may replace them as necessary or otherwise adjust them as desired.

### DESCRIPTION OF THE DRAWINGS

The advantages and features of the present disclosure will become better understood with reference to the detailed description taken in conjunction with the accompanying drawings, in which

FIG. 1A shows an exemplary embodiment of an adjustable foot and toe cleaning device, in accordance with an exemplary embodiment of the present disclosure;

FIG. 1B shows another exemplary embodiment of an adjustable foot and toe cleaning device, in accordance with an exemplary embodiment of the present disclosure;

FIG. 2 shows an exemplary locking mechanism disposed on a head element of the cleaning device, in accordance with an exemplary embodiment of the present disclosure;

FIG. 3 shows an exemplary peg and aperture configuration of locking mechanism of the cleaning device, in accordance with an exemplary embodiment of the present disclosure;

FIG. 4 shows an exemplary locking mechanism disposed on a plate of the cleaning device, in accordance with an exemplary embodiment of the present disclosure; and

FIG. 5 shows an exemplary locking mechanism disposed on a finger like-protection of the cleaning device, in accordance with an exemplary embodiment of the present disclosure.

### DESCRIPTION OF THE DISCLOSURE

The best mode for carrying out the present disclosure is presented in terms of its preferred embodiments, herein depicted in the accompanying figures. The preferred embodiments described herein detail for illustrative purposes are subject to many variations. It is understood that various omissions and substitutions of equivalents are contemplated as circumstances may suggest or render expedient, but are intended to cover the application or implementation without departing from the spirit or scope of the present disclosure. Furthermore, although the following relates substantially to one embodiment of the design, it will be understood by those familiar with the art that changes to materials, part descriptions, and geometries can be made without departing from the spirit of the disclosure.

The terms “a” and “an” herein do not denote a limitation of quantity, but rather denote the presence of at least one of the referenced item.

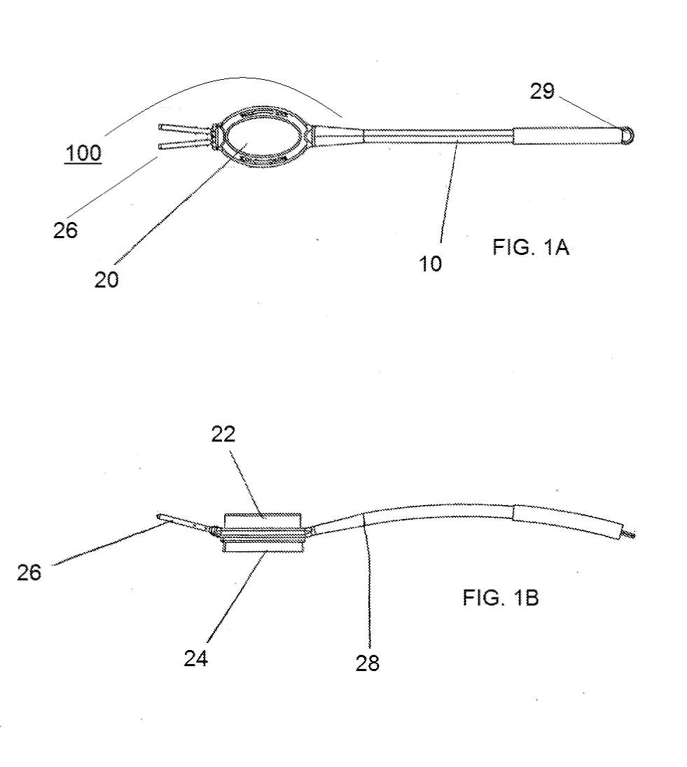

Referring to FIG. 1A, the present disclosure presents an adjustable foot and toe cleaning device 100 for allowing a user to clean his or her feet and toes with minimal effort or bodily movement. The device comprises an elongate handle 10 capable of being grasped by a user's hand and a head implement 20 coupled an end of the elongate handle 10. The elongate handle 10 may comprise a rubber grip portion 30 for assisting the user in grasping and holding onto the device and may comprise depressions or contours that may receive a user's finger or fingers to facilitate a user's handling of the device. The elongate handle 10 may be generally curved from end to end, or may instead be straight. The elongate handle may further comprise an aperture 29, through which aperture a length of string or rope may be threaded, such that the string or rope may serve as a lanyard for the device. The head implement 20 is coupled to the elongate handle 10 by, for example, a spring joint mechanism, which provides for the flexible movement of the head implement 20 with respect to the elongate handle 10.

Referring to FIG. 1B, the head implement 20 includes at least one of a brush element 22 and a porous element 24 and additionally features finger-like projections 26 extending outwardly therefrom, and in a preferred embodiment comprises one of each of the brush element 22 and porous element 24. In an embodiment, the porous element 24 comprises a pumice stone or other similar rigid material capable of exfoliating a user's skin. In an embodiment, the porous element 24 may comprise a sponge or other resilient and/or absorbent material. The head implement 20 may also comprise depressions or contours that may receive a user's finger or fingers to facilitate a user's handling of the device.

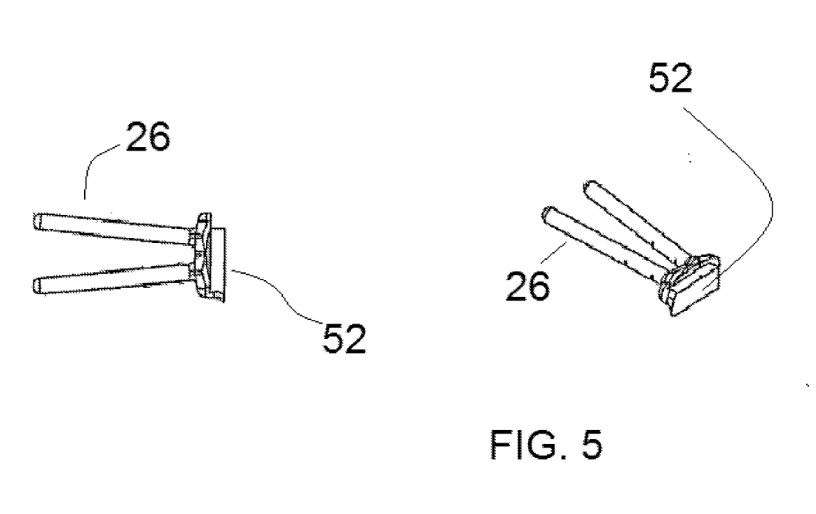

In a preferred embodiment, two finger-like projections 26 extending from the head implement 20, which finger-like projections 26 are capable of comfortably fitting within adjacent spaces between a user's toes and are comprised of a soft, absorbent material. Preferably, and as shown in FIG. 1A and FIG. 5, the finger-like projections 26 will comprise a “V” or angular configuration (wherein the vertex is the shared point where the finger-like projections 26 extend outwardly from the head implement 20) to maximize the cleaning efficiency of the device. It will be apparent, however, that the arrangement of the finger-like projections 26 is not limited to any particular shape or configuration, and, furthermore, that the present disclosure in no way limits the number of finger-like projections 26 that may be coupled to or otherwise used with the disclosed device or the material of which same are comprised. In an embodiment, the exterior surface of the finger-like projection comprises a sponge or other absorbent material.

In an embodiment, the finger-like projections 26 may comprise hollow interior region, which hollow interior region may receive a vibration mechanism to allow the finger-like projections 26 to vibrate. In an embodiment, the vibration mechanism comprises a motor with a rotating gear and a weight coupled to said gear. The weight is mounted away from the center of the gear, such that when the motor causes the gear to rotate, the off-center mounting of the weight causes the vibration mechanism to vibrate, which vibrating is imparted to the finger-like projections 26. It will be apparent that the vibrational mechanism includes a power source (such as a battery) and a switch for activating and deactivating the motor. The power source may be disposed within a finger-like protection 26, or may be disposed in the elongate handle 10, and the switch may be disposed on a finger-like projection 26 or elsewhere on the device 100. In the embodiment where the power source and switch are disposed elsewhere than in and on a finger-like projection, it will be apparent that the device will comprise requisite couplings to permit the transmission of power and control to the vibration mechanism. The vibration of the finger-like projections 26 may improve the cleaning efficacy of the device by gently, but with more force, removing dirt and other contaminants from a user's toes.

Each of the brush element 22, porous element 24, and finger-like projections 26 is preferably removably coupled to the head implement 20, which allows the user to switch out the various components for replacements when the existing ones exhaust their useful life, or where the user desires to change the components available on the device. In providing for such removable coupling, the present disclosure provides for locking and fastening mechanisms 50 to engage and secure each of the aforesaid components to the head implement 20. Once the user is ready to remove any of the components thereof, he or she need only disengage the corresponding locking mechanism 50, exchange or replace the subject component, and thereafter reengage that locking mechanism 50. Furthermore, the head implement 20 may be detachable from the elongate handle 10, such that a user may perform cleaning with the head implement 20 (and accompanying brush element 22, porous element 24 and finger-like projections 26) directly.

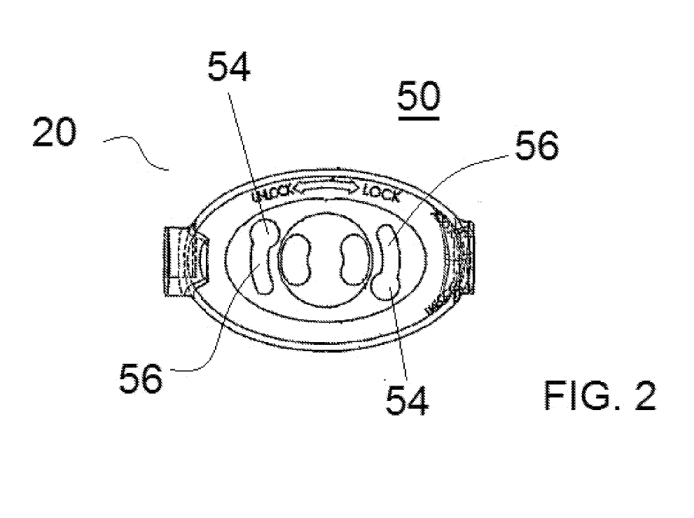

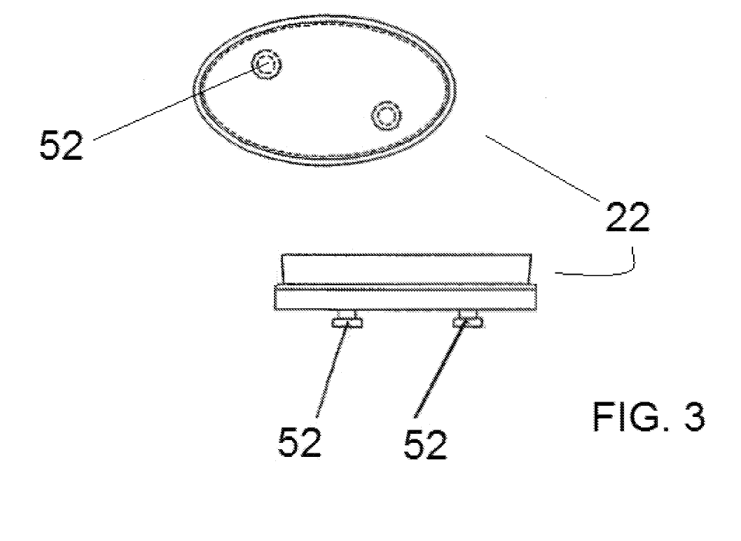

In an exemplary embodiment, the locking mechanism 50 of the brush element 22 comprises a set of interlocking pieces comprising at least one peg 52 disposed on the brush element 22 and at least one aperture 54 (shown in FIG. 2) disposed within the head implement 20 for receiving the at least one peg 52. Preferably, two pegs 52 and two apertures 54 are used. In an embodiment, after the pegs 52 are received within the respective apertures 54, the brush element 22 may be rotated in a plane parallel to the surface of the head implement 20 comprising the apertures 54. Such rotation causes each of the pegs 52 to travel along a track 56 (also shown in FIG. 2) defined within the head implement 20, which tracks narrow in width past the respective apertures 54 to secure the brush element 22 and head implement 20 to one another.

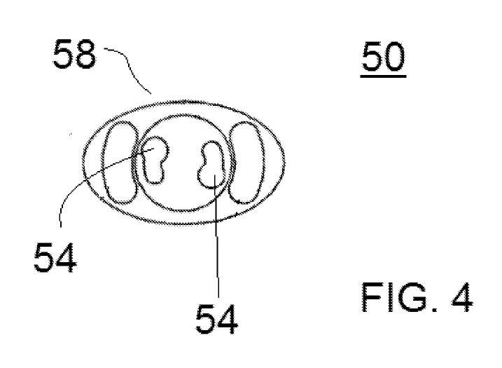

In an embodiment, the locking mechanism 50 of the porous element 24 is similar to that of the brush element 22, provided however that the pegs 52, apertures 54, and tracks of the brush element 22 and porous element 24 are configured in a manner such that the locking and unlocking of each such component may be performed without any interference to the other such component. For example, the apertures 54 of the locking mechanisms 50 of the brush element 22 and the porous element 24 may be disposed in separate, generally concentric, non-intersecting regions of the head implement 20. In an embodiment, and as shown in FIG. 4, the apertures 54 for receiving the pegs 52 of the brush element 22 and porous element 24 are disposed within a plate 58 rather than the head implement 20 itself, which plate 58 is removably coupled within the head implement 20.

In another exemplary embodiment and as shown in FIG. 5, the locking mechanism 50 of the finger-like projections 26 is similarly defined by a set of interlocking pieces comprising at a sliding peg 52 disposed on a side or end of the finger-like projections 26 and a corresponding aperture on the head implement 20 for receiving the sliding peg 52 of the finger-like projections 26. After the sliding peg 52 is received within the aperture, the finger-like projections 26 may be rotated in a plane perpendicular to the surface of the head implement 20 that contains the aperture. In a preferred embodiment, the amount of rotation from an unlocked position of the finger-like projections 26 to a locked position thereof is approximately 180 degrees.

By providing the brush element 22, porous element 24, and finger-like projections 26 via removable coupling, the disclosed device permits the user to replace those components as desired, such as where any of them become worn out from use. This obviates the purchase of an entire new foot and toe cleaning device 100 and precludes the user from having to either stop using the disclosed device or from continuing to use the disclosed device but with diminished cleaning potential and efficiency.

In order to further support the user in using the disclosed device with minimal effort and bodily movement, and in a further embodiment, the elongate handle 10 may comprise at least one joint 28 (shown in FIG. 1B) for adjusting the angular configuration of the elongate handle 10. That is, in such an embodiment, the user may adjust the angle at which each segment of the elongate handle 10 extends from the corresponding joint 28 in order to conform the structure of the device in a manner that is most comfortable for the user and which will provide the user with maximum access to his or her extremities, such as feet and toes, via the device. In a further embodiment, the elongate handle 10 may comprise a telescoping or other extension configuration for extending the length and reach of the disclosed device.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the disclosure and various embodiments with various modifications as are suited to the particular use contemplated.

What is claimed is:

1. An adjustable foot and toe cleaning device, said device comprising
an elongate handle,
a head implement coupled to said elongate handle, said head implement comprising at least one of a brush element, a porous element and at least one finger-like projection.

2. The device of claim 1, wherein said head implement is removably coupled to said elongate handle via a locking mechanism.

3. The device of claim 1, wherein said elongate handle further comprises at least one joint for adjusting the angular configuration of said handle.

4. The device of claim 1, wherein said at least one finger-like protection is detatchably coupled to said head implement.

5. The porous element of claim 1, wherein said porous element comprises one of pumice stone and sponge.

6. The elongate handle of claim 1, wherein said elongate handle further comprises at least one contour thereon that may receive a user's finger or fingers to facilitate a user's handling of the device.

7. The elongate handle of claim 1, wherein said elongate handle further comprises at least one aperture for receiving a lanyard.

8. The head implement of claim 1, wherein said head implement further comprises at least one contour thereon that may receive a user's finger or fingers to facilitate a user's handling of the device.

9. The device of claim 1, said device further comprising two finger-like projections, wherein said finger-like projections are attached to and extend away from said head implement at a common point on said head implement.

10. The device of claim 1, wherein said elongate handle has an adjustable length.

11. The device of claim 1, wherein said at least one finger-like projection comprises a vibration mechanism, said vibration mechanism capable of causing said at least one finger-like projection to vibrate.

12. The vibration mechanism of claim 11, said vibration mechanism comprising
a power source,
a switch,
a motor,
a gear, and
a weight disposed off-center upon said gear,
such that when said motor is powered by said power source, said gear rotates, and said weight being disposed off-center upon said gear imparts a vibrational force.
